(19) United States
(12) Patent Application Publication
(10) Pub. No.: US 2008/0279907 A1
(43) Pub. Date: Nov. 13, 2008

(54) Antimicrobial medical devices and methods for making and using same

(75) Inventors: Stephen R. Ash, Lafayette, IN (US); Janusz Steczko, West Lafayette, IN (US)

Correspondence Address: KRIEG DEVAULT LLP, ONE INDIANA SQUARE, SUITE 2800, INDIANAPOLIS, IN, 46204-2079, US

(73) Assignee: Ash Access Technology, Inc.

(21) Appl. No.: 11/801,616

(22) Filed: May 10, 2007

(51) Int. Cl. A01N 25/34; A01N 33/02; A01N 43/26; A01N 43/84; A01P 1/00

(52) U.S. Cl. 424/422; 514/12; 514/224.8; 514/297; 514/438; 514/544; 514/646

(57) ABSTRACT

In general, this application is directed to medical devices that exhibit antimicrobial activity and to methods for preparing and using the medical devices. The medical devices of the present application include a polymeric portion that has been impregnated with a paraben and an organic dye in a manner whereby the paraben and organic dye exhibiting antibacterial properties. In one form, the paraben is impregnated into the polymeric portion before impregnation thereof with the organic dye. In another form, it is contemplated that the polymeric material may include methyl paraben, propyl paraben, and methylene blue. It is further contemplated that the polymeric material is effective in releasing at least one of the paraben and organic dye to prohibit bacterial growth in surrounding tissue and/or fluid.

### BACKGROUND

In general this application is related to implantable and other medical devices exhibiting antimicrobial activities, methods for preparing the medical devices, and methods for using the devices. More specifically, the present application is directed to implantable and other medical devices that include a polymeric component or matrix impregnated with one or more paraben compositions and/or one or more organic dye compositions in a manner whereby one or both of the paraben(s) and the organic dye composition(s) is releasable therefrom and exhibits antimicrobial activity.

The progress of modern medicine has been advanced, in part, by the wide use of invasive medical devices, including catheters. Several million intravascular catheters are purchased each year by US hospitals and clinics. Use of these devices places large numbers of patients at risk for catheter-related bloodstream infection (2) (CRBSI). Most serious infections, such as bacteremia or fungemia, are associated with central venous catheters (CVCs) rather than small peripheral catheters (3-5). Even when aseptic techniques are used during insertion and maintenance of the catheter, recent history suggests that at least 1 and up to 5 of every 20 CVCs inserted will be associated with an episode of bloodstream infection (6). The mortality attributable to these infections in prospective studies has been reported to be 12 to 25% (5, 7), and the cost attributable for each event has been reported to be between $3,700 and $29,000 (7, 8). In chronic CVCs for dialysis, the incidence of infection is 4-6% of the patient population each month (28).

Several factors pertaining to the pathogenesis of CRBSI's have been identified during the last decade. Most common catheter-related bloodstream infections are believed to originate from microbes colonizing catheter hubs and the skin surrounding the insertion site (9-11). Therefore, there is a need for technology development aimed at reducing colonization of microbes at the catheter insertion site on or about the hubs and/or minimizing microbial infection toward the intravascular segment of the catheter.

Technology of inhibiting the adherence and growth of pathogens reaching the intravascular catheter segment is also needed. Organisms that adhere to the catheter surface maintain themselves by producing “extracellular slime”, a substance rich in exopolysaccharides, often referred to as fibrous glycocalyx or microbial biofilm (12, 13). The organisms embed themselves in the biofilm layer, becoming more resistant to antimicrobial agents due to a dormant metabolism with different metabolic pathways than normal bacteria (14, 15). The colonization of microbes on and about CVCs is very common (16). The risk of infection is directly proportional to the quantitative level of organisms multiplying on the surface of the intravascular segment of the catheter. Several factors can potentiate the multiplication and spread of microorganisms from biofilm increasing the risk of bloodstream infections, including breaking of stalks of bacterial biofilm from the surface of the catheter. Once in the bloodstream, bacteria can multiply and cause serious illness such as sepsis (systemic inflammatory response syndrome) or metastatic infections (in bones, joints, heart valves, skin, etc.). Finally, catheter-related infection can result in local septic thrombophlebitis, having its origin in a thrombin sheath that often covers the internal and external surface of the intravascular segment of the catheter. The sheath is composed of many different proteins such as fibrin, fibrinogen, fibrinectin, laminin, thrombospondin, and collagen that strongly bind some microorganisms such as Staphylococcus aureus, Candida albicans, or coagulase-negative staphylococci. The environment is ideal for multiplication of microbes; therefore, a correlation between thrombosis and infection can be observed at the clinical level (17).

Historically, there have been four approaches for preventing catheter infection. First, aseptic hub devices such as puncture membranes inhibit the introduction of microbes into the catheter lumen. However, this does not protect the external surface of the catheter or around the site of implantation.

Second, an ionic silver composition deposited on the outer surface of the catheter exhibits broad-spectrum antimicrobial activity at the insertion-subcutaneous junction. However, this coating has only minimal release of silver from the surface and does not protect the internal surfaces.

Third, an anticoagulant/antimicrobial lock (flush) is particularly useful for long-term catheters where hub contamination leads to lumen colonization and, ultimately, to bloodstream infection (18-20). A wide spectrum of antibiotics can be used in lock solutions as well, but general use of antibiotics in lock solution is limited due to the certainty of inducing bacterial antibiotic resistance. Moreover, microbial biofilm is able to inhibit the activity of some glycopeptide antibiotics such as vancomycin, making antibiotic lock solutions less effective (15). This approach does not protect the external surface of the catheter.

Fourth, bonding of antibiotics to catheters for protecting the external and internal surfaces of the catheter has been employed. Since the first reports in the 1980's of oxacillin bonded to polytertrafluoroethylene grafts (21, 22), many other drugs, including antibiotics or chemical molecules, were successfully attached to catheter surfaces.

Various approaches for preventing catheter infection that have been developed and employed to date provide marked benefits; however, there are still shortcomings in this technology. For example, the use of antibiotics is problematic for multiple reasons. Most drugs or antibiotics suitable for use in catheters do not exhibit broad spectrum antibiotic, antiviral, and/or antifungal activity. Prolonged exposure to immobilized antibiotics (as they are released) may lead to the development of bacterial resistance that may be difficult to detect (23).

In view of the above, it is apparent that further advances in the prevention of catheter infections and the prevention of infections relating to other medical devices are needed. The present invention addresses this need.

### SUMMARY

The present application relates to implantable medical devices that exhibit antimicrobial activity and the manufacture and use thereof. Various aspects of the application are novel, nonobvious, and provide various advantages. While the actual nature of the invention covered herein can only be determined with reference to the claims appended hereto, certain forms and features, which are characteristic of the preferred embodiments disclosed herein, are described briefly as follows.

Medical devices operable to prevent colonization of microbes and/or to kill bacteria contacting the surface of the device and in the surrounding tissues are provided by placing one or both of paraben compounds and organic dye compounds within the polymeric material used in construction of the devices. The medical devices may be implanted or used external to the patient in delivery of fluid to the patient. A method is described for initially impregnating the polymeric material with one or more parabens. An additional method is described for activating organic dyes so that they will avidly absorb into a variety of polymers in a few hours, penetrating through the entire depth of the polymer material used in construction of the medical devices. A method for impregnating a paraben impregnated polymeric material with an activated organic dye is also described. These processes can be performed after extrusion or casting of the polymer material. Alternatively, the paraben(s) and/or organic dye(s) could be mixed into the polymeric material before extrusion or casting. Because of the large store of paraben and organic dye within the polymer, the polymer is bactericidal to any bacteria contacting the material surface and also releases one or both of the paraben(s) and organic dye(s) into surrounding biofilm and tissues, killing bacteria in the vicinity of the surface of the medical device.

In one form, the present application provides a medical device for implantation into tissue of a patient or use in preparation of a fluid to be delivered to a patient. The medical device includes a polymeric material impregnated with a paraben and an organic dye, with at least one of the paraben and the organic dye exhibiting antibacterial activity. The polymeric material is also effective in releasing at least one of the paraben and the organic dye therefrom, such as for example, into surrounding tissue and/or fluids to prevent surrounding bacterial growth.

In another embodiment, a polymeric material for use in a medical device is provided. The material comprises a paraben and an organic dye impregnated therein.

In yet another embodiment, a method of manufacturing polymeric material for a medical device is provided. The method includes contacting a polymeric material with a first liquid composition including a paraben to impregnate the polymeric material with the paraben, thereby providing a paraben impregnated polymeric material; and contacting the paraben impregnated polymeric material with a second liquid composition including an organic dye to impregnate the paraben impregnated polymeric material with the organic dye, thereby providing a paraben and organic dye impregnated polymeric material.

In still other embodiments, a method of treating a patient having an indwelling medical device is provided. The method includes selecting a medical device comprising a polymeric material impregnated with a paraben and an organic dye, with one or more of the paraben and the organic dye exhibiting antibacterial activity and implanting the device into a patient. The paraben and organic dye impregnated polymeric material is effective to release a portion of at least one of the paraben and the organic dye to prohibit bacterial growth.

Further features, aspects, forms, advantages and benefits shall become apparent from the description and drawings contained herein.

### BRIEF DESCRIPTION OF THE DRAWING

FIG. 1 is a perspective view of one embodiment of a catheter provided in accordance with the present application.

FIG. 2 is a perspective view of one embodiment of a suture treated in accordance with the present application.

FIG. 3 is a one embodiment of a surgical staple treated in accordance with the present application.

FIG. 4 is a schematic illustration of one embodiment of a dialysis system that can include a variety of treated components in accordance with the present application.

FIG. 5 is a graph illustrating the bactericidal properties of treated polyurethane (EG) and polyurethane/polycarbonate materials (PC) impregnated with methylene blue against E. coli in accordance with the present application. Control includes a non-impregnated surface (NIS) with contact to the bacteria solution.

FIG. 6 is a graph illustrating the bactericidal properties of a polyurethane (EG) and a polyurethane/polycarbonate (PC) material impregnated with methylene blue against S. aureus in accordance with the present application. Control includes a non-impregnated surface (NIS) with contact to the bacteria solution.

FIG. 7 is a graph illustrating the bactericidal properties of a polyurethane (EG) and a polyurethane/polycarbonate (PC) material treated with methylene blue against S. epidermidis in accordance with the present application. Control includes a non-impregnated surface (NIS) with contact to the bacteria solution.

FIG. 8 is a graph illustrating the release rate of propyl paraben from selected polymer samples which were exposed to propyl paraben. The samples varied in the amount of exposure to the propyl paraben.

FIG. 9 is a graph illustrating the release rate of methyl paraben from selected polymer samples which were exposed to methyl paraben. The samples varied in the amount of exposure to the methyl paraben.

FIG. 10 is a graph illustrating the release rate of methylene blue from selected polymer samples impregnated with methylene blue.

FIG. 11 is a graph illustrating the release rate of methylene blue from selected polymer samples impregnated with parabens and methylene blue. The selected polymer samples vary in the amount of time in which they were exposed to parabens during paraben impregnation.

FIG. 12 is a schematic diagram of an experimental setup for measuring perfusion of parabens and methylene blue through a polycarbonate membrane.

### DETAILED DESCRIPTION OF PREFERRED EMBODIMENTS

For the purposes of promoting an understanding of the principles of the inventions described herein, reference will now be made to the embodiments illustrated herein and specific language will be used to describe the same. It will nevertheless be understood that no limitation of the scope of any subject matter described and claimed herein is thereby intended. Any alterations and further modifications in the described processes, systems, or devices, and any further applications of the principles described and illustrated herein, are contemplated as would normally occur to one skilled in the art.

In general, medical devices according to the present application exhibit antimicrobial and/or antiviral properties. Chronically implanted medical devices are an example of devices contemplated by the present application, in which a long-term antimicrobial property is of great benefit to patients. Other medical devices contemplated by the application are devices that are not implanted but that provide an improved benefit by having the ability to prevent microbial growth on their surface and/or within a biofilm building on the surface thereof. An example is a dialysis machine used for chronic dialysis therapy. Within dialysis centers these machines are typically used for several years in treatment of many different patients. The dialysate fluid they deliver is rich in nutrients, so bacterial growth within the dialysate fluid is a continuing problem. Bacterial growth in the dialysate exceeding 2000 organisms per ml can result in transfer of endotoxins to patients with resulting fever, low blood pressure, nausea, and other symptoms. Bacterial content of the dialysate is measured frequently, but only on randomly selected machines. To diminish bacterial content of the dialysate, each machine is disinfected each night after treatment of several patients. Biofilm builds on all of the hydraulic pathways of the dialysis machine, making disinfection somewhat difficult especially after a heavy bacterial contamination. Many of these pathways are constructed of polymers, either flexible or rigid. Incorporation of paraben(s) and/or organic dye(s) into these polymers as described herein prevents the build-up of biofilm and/or proliferation of bacteria in, on or around the surfaces of the hydraulic pathways in an ongoing manner, resulting in a reduction in the bacterial load of dialysate.

Looking one step further back in the dialysis process, the water system providing pure water for dialysis is a significant source of bacteria in dialysate. The presence of bacteria in the purified water source in an amount of more than 200 bacteria per ml can result in the machine becoming contaminated and the dialysate developing high concentrations of bacteria with adverse events described above. The water system contains a number of components to purify water and some to eliminate bacteria; however one component of the purification system includes activated charcoal, which also removes chlorine from the water, making the rest of the system vulnerable to growth and proliferation of bacteria and/or biofilm. The entire water treatment system typically includes membranes and pipes made of polymer materials. Impregnation of these materials with paraben(s) and/or organic dye(s) as described herein results in a reduction of the bacterial content of the water used to make dialysate, which diminishes bacterial exposure of dialysis patients.

The medical devices provided by the present application are formed of, or include a portion formed of, a polymeric material or matrix that has been impregnated with one or more of a paraben and an organic dye compound. The term “paraben” is used herein to refer to an alkyl or benzyl ester of p-hydroxybenzoic acid and their sodium salts. In one form, the polymeric material is impregnated with methyl paraben, propyl paraben, and methylene blue. Generally, the paraben(s) can be selected from: methyl paraben, ethyl paraben, propyl paraben, butyl paraben, isobutyl paraben, isopropyl paraben, and benzyl paraben. The organic dye can be selected from: methylene blue and its analogues, toluidine blue, methylene violet, azure A, azure B, azure C, brilliant cresol blue, thionin, methylene green, bromcresol green, gentian violet, acridine orange, brilliant green, acridine yellow, quinacrine, trypan blue, and trypan red. In one embodiment, the organic dye selected for use has a phenothiazine ring structure, acridine ring, or similar structure. In another embodiment, the dye is operable as an electron donor or electron receptor in an oxidation-reduction reaction. In yet another embodiment, the dye exhibits a change in oxidative potential on exposure to light (referred to herein as a “photo-oxidant”). In alternative embodiments, the organic dye compound is bound to carbon chains or embedded or absorbed into the polymeric matrix previously impregnated with the paraben(s).

The polymeric material can slowly release one or both of the absorbed paraben(s) and organic dye compound into the surrounding tissue or fluid. The rate of release can extend over one, two, or more months. In one form, the rate of release can be controlled by controlling the amount of paraben(s) and organic dye compound absorbed into the polymeric material. Moreover, in regard to the organic dye compound, the amount thereof absorbed into the polymeric material as well as the release rate thereof from the polymeric material may be controlled by the amount of paraben(s) impregnated into the polymeric material prior to impregnation with the organic dye compound. For example, while it is not intended that the subject matter described and claimed herein be limited by any theory, it is believed that a greater amount of paraben(s) impregnated into the polymeric material will allow less of the organic dye to be impregnated in the material but will hold the organic dye in the polymeric material for a longer period of time. In another form, it is believed that the polymeric material may be impregnated with a smaller volume of the paraben(s) but at a higher concentration. In this form, the polymeric material may then be impregnated with a higher volume of the organic dye while the higher concentration of the paraben(s) still retains the organic dye in the polymeric material for a desired amount of time. It is also contemplated that the impregnatable amount of paraben(s), and consequently the impregnatable amount of the organic dye as well as the release rate thereof, may be controlled by modifying the duration of time to which the polymeric material is exposed to the paraben(s) during impregnation thereof with the paraben(s). For example, in one form, extending the duration of time in which the polymeric material is impregnated with the paraben(s) before being impregnated with the organic dye will increase the amount of the organic dye released from the material. However, other ways are further contemplated by which the loading and release of the organic dye may be controlled, as would be appreciated by one having skill in the art.

It has also been determined that the treated devices do not lose efficacy upon extended storage. For example, the devices can be prepared and stored either in a sterile container or in clean packaging until needed. When desired, the devices can be sterilized, if necessary, and then immediately used or implanted in patients. Upon implantation or contact with surrounding tissue, the treated polymeric material begins to immediately release one or more of the absorbed paraben(s) and/or organic dye compound at a substantially steady rate as evidenced by the resulting antimicrobial activity of the devices.

In one form, the polymeric material can be used and treated in accordance with the present application to prepare medical catheters. The catheters may be, for example, peripherally insertable central venous catheters, dialysis catheters, long term tunneled central venous catheters, peripheral venous catheters, short-term central venous catheters, arterial catheters, pulmonary artery Swan-Ganz catheters, urinary catheters and long term urinary devices. It is also contemplated. that the treated polymeric material may be used in other implantable medical devices, including: vascular grafts, vascular stents, vascular catheter ports, heart valves, pacemaker leads, pacemakers, pacemaker capsules, artificial hearts, hydrocephalus shunts, peritoneal catheters, wound drain tubes, sutures, surgical staples, intrauterine devices, urinary dilators, hydrocephalus shunts, permanent or temporary joint replacements, catheter connectors, connector caps, subcutaneous or transcutaneous ports, contact lenses, implanted artificial lenses, implantable lungs, implantable infusion pumps and numerous other implantable medical devices and the like. It is also contemplated that the polymeric material treated in accordance with the present application can be used in external medical devices including dialysis machines, dialysis water delivery systems, water circuits within the dialysis unit, water delivery systems for respirator therapy, and water or fluid delivery systems for any other medical use if used for extended periods of time.

It is also contemplated that a wide variety of other polymeric medical devices can be treated as described above. For example, medical devices that are amenable to treating and impregnation by one or more of a paraben and an organic dye solution include non-metallic materials such as thermoplastic or polymeric materials. These materials can be biodegradable (or resorbable polymers) and non-biodegradable polymers. Examples of non-biodegradable polymers that can be used in the present application include, but are not restricted to: rubber, plastic, polyethylene, polyurethane, silicone, Gortex (polytetrafluoroethylene), Dacron (polyethylene tetraphthalate), Teflon (polytetrafluoroethylene), latex, elastomers, Dacron sealed with gelatin, collagen or albumin, acrylics, polyacrylates, polymethacrylates, fluorocarbons, hydrogels, polyacetals, polyamides, polyurethane/polycarbonate, polyesters, poly(ether, ketones) (PEK), polyimides (nylons), polyolefins, polystyrene, polysulfones, polyurethanes, polyvinyl chloride (PVC), polycarbonate, silicone rubbers, polyethylene, polyurethane, latex, polyesters, poly(ethylene-terephthalat-e) and blends of these polymers. Examples of biodegradable polymers for use in the present application include, but are not restricted to: poly(amino acids), polyanhydrides, polycaprolactones, poly(lacti-glycolic acid), polyhydroxybutyrates, polyorthoesters, and blends of these polymers. The polymers for use in the present application can be polymer blends, homopolymers, and/or copolymers. Use of the term co-polymers is intended to include within the scope of the application polymers formed of two or more unique monomeric repeating units. Such co-polymers can include random copolymers; graft copolymers; block copolymers; radial block, diblock, and triblock copolymers; alternating co-polymers; and periodic co-polymers. Use of the term polymer blend is intended to include polymer alloys, semi-interpenetrating polymer networks (SIPN), and interpenetrating polymer networks (IPN).

A catheter used in connection with the present application typically can either be an acute (temporary) or chronic (long-term) catheter surgically implanted in an animal. The catheter usually is inserted into a vein or artery. The catheter is typically used in varying intervals to administer fluids, nutrients, and medications into the body. The catheter also can be used to withdraw body fluids, such as blood for hemodialysis treatment. When not in use, the catheter remains in its position, commonly an intravascular position, until a subsequent treatment is performed.

The catheters that may be used in accordance with this application include known and commonly used catheters and are readily available from a variety of commercial sources and catheters yet to be designed. The catheters may vary in configuration and size, and the subject matter described herein is not intended to be limited to any specific shape or size. One type of catheter commonly used in accordance with this application is a tunneled catheter that includes a cuff for ingrowth of tissue to anchor the catheter. Examples of catheters that may be used include, but are not restricted to, an ASH SPLIT CATH and DUOSPLIT by Ash Access Technology, Inc. (Lafayette, Ind.) and Medcomp (Harleysville, Pa.); Tesio Catheters by Medcomp; PERM CATH by Quinton Instrument Company (Seattle, Wash.); and HICKMAN and VAS CATH by Bard, Inc. (Salt Lake City, Utah). Catheters containing totally subcutaneous ports are also useful in the present application; examples include LIFESITE by Vasca (Topsfield, Me.); and DIALOCK by Biolink, Inc. of (Boston, Mass.). The catheters are manufactured to function for several months. For example, TESIO catheters can last for up to four years with proper intervention. However, in actual practice, catheters have heretofore exhibited limited longevity because of occlusion and/or infection. The catheters frequently must be removed and/or replaced upon the occurrence of occlusion and/or infection.

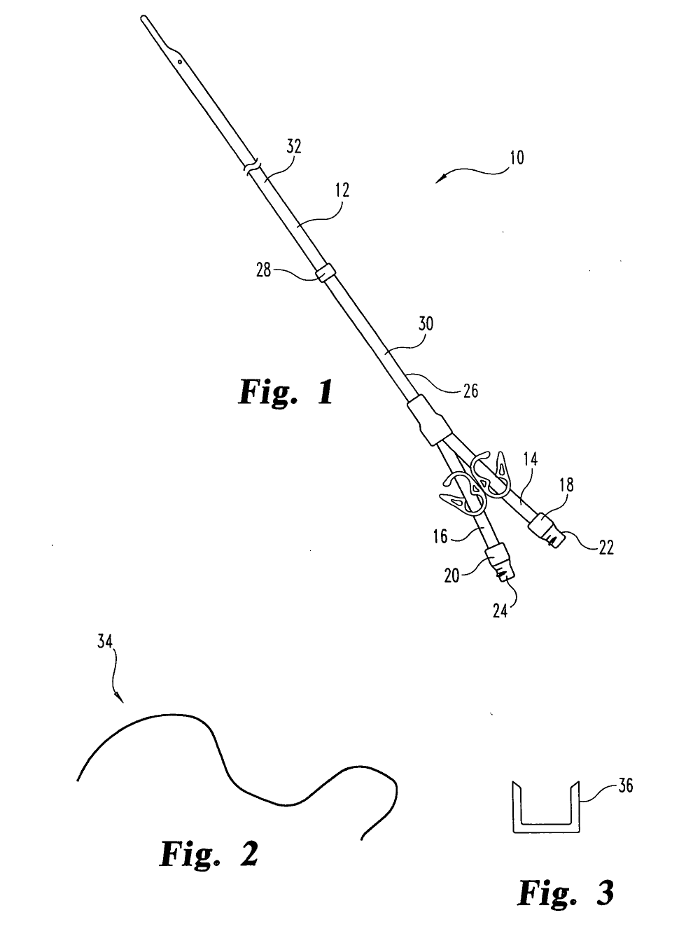

FIG. 1 is a perspective view of one embodiment of a medical device 10 including a catheter 12. Catheter 12 includes first and second lumens 14 and 16, respectively. Each lumen 14 and 16 includes a hub 18 and 20 and a puncture cap 22 and 24. The lumens 14 and 16, the hubs 18 and 20, and the puncture caps 22 and 24 can be formed of the same or different polymeric materials. An outer sheath 26 surrounds a portion of lumens 14 and 16. A cuff 28 encircles sheath 26. Additionally, the lumens 14 and 16 and hubs 18 and 20 can be attached using a biocompatible glue (not shown). The treatment of medical devices such as catheter 12 according to the present application provides distinct advantageous. For example, each of the components of catheter 12 can be treated and impregnated with one or more of the paraben(s) and organic dye compound regardless of the polymeric material used to form the components. Consequently, each component can exhibit antimicrobial activity. Additionally, if desired, selected portions of catheter 12 need not be treated. For example, lower portion 32 of sheath 26 can be left untreated, while cuff 28 and the implantable, upper portion 32 can be treated with the organic dye compound.

FIGS. 2 and 3 illustrate other implantable medical devices that may be treated and prepared in accordance with the present application. FIG. 2 is a perspective view of surgical suture material 34 while FIG. 3 is an illustration of a surgical suture 36.

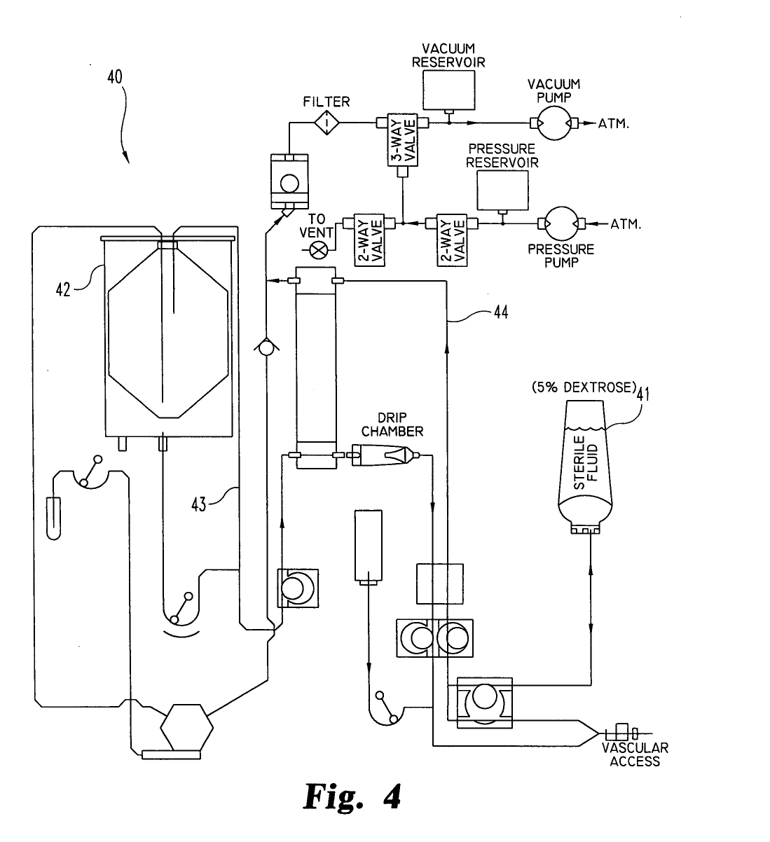

FIG. 4 is a schematic illustration of a dialysis machine 40 that includes various components that can be treated in accordance with the present application. Dialysis unit 40 includes various flexible and non-flexible polymeric components, like for example, containers 41 and 42, that can contain a variety of fluids. Additionally various plastic tubing such as tubing 43 and 44, which are hydraulic pathways within the unit, can be treated in accordance with the present application.

In one form of the present application, a polymeric material suitable for use in a medical device is impregnated with one or more paraben(s). In another form, the polymeric material is impregnated with one or more paraben(s) before impregnation with an organic dye compound. In either of these forms, the medical device may be a catheter selected for implantation into a patient, such as, for example, into a vascular site of a patient, and the polymeric material thereof can be pretreated with a solution including a paraben to treat and impregnate the catheter surfaces with the paraben. Once impregnated with the paraben(s), the treated portion of the catheter is generally infection-resistant. Moreover, in a form including both paraben(s) and an organic dye compound, the paraben(s) may increase the amount of the organic dye impregnated into the polymeric material and also controls the release of the organic dye from the polymeric material, as discussed above. For impregnation with paraben(s), it is generally sufficient to soak the catheter in an excess volume of an aqueous paraben solution, followed by washing in water or in a solution mimicking physiological conditions of use to remove non-absorbed material. In one embodiment, the catheter is soaked in a high concentration of paraben that exceeds the solubility limits of the paraben in water. In another embodiment, the paraben is dissolved in a diol, alcohol, water or mixtures thereof, and the catheter is soaked therein.

One embodiment of the present application, therefore, is a method for impregnating a non-metallic medical implant with a paraben comprising the steps of forming an aqueous solution of an effective concentration of a paraben to inhibit the growth of bacterial and fungal organisms and/or to control the loading and release of the organic dye compound; and applying the solution to at least a portion of a medical implant under conditions where the paraben permeates the material of the medical implant. The paraben solution can have a wide variety of concentrations, depending upon the amount of paraben one desires to become impregnated in the catheter or other device. In one form, the solution may include multiple paraben compounds, like for example, methyl paraben and propyl paraben. In addition, the amount of time that the catheter or other device is soaked in the solution can be varied to vary the degree of impregnation. Typically it will be desired to soak the catheter for at least about two hours, and often significantly longer.

After the paraben impregnated implant is contacted with the solution, and optionally removed from the solution and allowed to dry, the implant can be rinsed with a liquid to remove excess paraben from the surface thereof. It is of course understood that the application can be used in certain embodiments to pre-treat a portion of a catheter or other device. In the case of an intravascular catheter, for example, it may be desirable to pre-treat only the lumen of the catheter. This can be done by simply placing a pretreatment solution into the lumen of the catheter rather than soaking the entire catheter. Alternatively, it is possible to pre-treat only a portion of a catheter that will reside within a patient's artery or vein, or to pre-treat only the portion that lies transcutaneously.

The paraben impregnated medical devices of the present application can also be prepared by combining one or more of the parabens with a polymeric material prior to manufacturing the medical device. For example, the paraben(s) can be combined and mixed with a pellitized polymer to provide an extrudable mixture, which is subsequently extruded or molded into the desired implantable medical device. In one such form, the resultant medical device may be further impregnated with the organic dye compound.

As indicated above, one form of the present application contemplates impregnating the paraben impregnated portions of the medical device with an organic dye compound. In some embodiments, the portions of catheter 12 impregnated with the organic dye compound can have a distinctly dark color. In these embodiments, if one or more of the lumens 14 and 16 and/or sheath 26 were cut through, it would be readily apparent that the polymeric material of these components has been completely impregnated with the organic dye. The depth of impregnation can be controlled by the concentration of dye, the length of treatment, and optionally, the temperature at which the polymeric material is treated. In one form, the concentration of an activating agent used during impregnation of the organic dye may control the depth of the impregnation. In preferred embodiments, the polymeric material is completely impregnated with the organic dye and exhibits a dark color from the outer surface through to the inner surface.

The resultant paraben and organic dye treated material is prepared to release organic dye at a relatively slow rate over months or years of use. Additionally, it is contemplated that the paraben(s) may also be released from the treated material. In other forms, the polymeric material of a catheter may only be treated with the organic dye compound, such as, for example, methylene blue.

Experiments have indicated that if the polymeric material is treated with only methylene blue throughout the entire body of the polymeric material, then placing the catheter in a volume of normal saline resulted in leaching of the dye over a one month period, turning the entire volume to an intense blue color. When the saline is replaced with fresh saline, exactly the same intense blue color developed in the fresh saline solution during the second month. This process of replacing the saline solution can be continued, that is, replacing the saline solution with fresh solution monthly, for at least nine months. The color resulting during the sixth month in the fresh saline solution is a light blue. If the process is continued for an additional 3 months or up to a total of 9 months, the resulting fresh saline solution is light blue in color, but the release of the dye continues. This indicates that the treated catheter is effective to release the antimicrobial dye at a rate and a concentration sufficient to inhibit microbial and/or bacteria growth for at least up to 9 months.

The organic dye may be impregnated into the paraben treated polymeric material or into a paraben free polymeric material by contacting the selected polymeric portion with a solution containing the organic dye compound or the organic dye compound and an activating agent.

The solvent for the solution can be water or saline and in one form may additionally include a citrate. Alternatively, other solutions can be used including, but not restricted to: alcohol, for example, ethanol or isopropyl alcohol; polar organic solvents, for example, chloroform; methylene chloride; acetone, tetrahydrofuran (THF); and mixtures of these solvents or other solvents as could be readily determined by those skilled in the art. It should be appreciated that the solvent may be selected based upon the nature of the polymeric material. It is particularly important to select a solvent that will not degrade or partly dissolve the polymeric material or any glue adhering the material to the medical device. Moreover, when impregnating the paraben treated material, the solvent should not degrade or dissolve the previously accomplished paraben impregnation.

The organic dye compound and the activator are added or suspended in the solvent. The order of addition is not critical. The organic dye compound and activator are present in amounts sufficient to impregnate the polymer within a desired amount of time. Preferably the organic dye compound is provided in an amount ranging between about 0.05 and 1.0 weight percent (wt %). More preferably, the organic dye is provided in an amount between about 0.05 and about 0.3 wt %. The activator can be provided in amounts ranging between about 0.01 and 3.0 wt %; more preferably, between about 1.0 and about 2.0 wt %. A buffer can also be included in the solution to maintain a pH of between about 4 and about 9. The buffer can be a commonly available buffering compound, for example, a citrate buffer, and can be readily selected by one skilled in the art. The temperature of the solution can be maintained between about 20° C. and slightly above ambient (25° C.) temperature. Higher temperatures can be utilized; however, this may significantly degrade and/or deform the polymeric material.

The polymeric material is immersed in the solution described above. The material can be maintained in the solution for a time sufficient to substantially impregnate the polymeric material and provide a substantially homogenous distribution of the organic dye throughout the polymer. The time can vary depending upon the concentration of organic dye compound, the activator, and the polymer thickness. In preferred embodiments, the polymeric material can be immersed in the solution from a time ranging between about one minute to several hours.

When desired, the polymeric material is removed from the solution. It has been observed that upon initially removing the polymeric material from the solutions of low organic dye concentration, there is no immediate, noticeable color change on the surface of the polymer. This material is then washed repeatedly with the solvent and/or a neutral physiological saline solution to remove any residual, non-bound organic dye compound or activator. The material is washed until the wash water exhibits no discoloration due to the organic dye or compound. Within a few minutes after washing and drying the polymeric material, the surface of the material begins to significantly darken. The treated material can then be stored until needed. Polymers exposed to higher concentrations of organic dye emerge from the treatment already colored by the dye, though the color may increase over time and/or exposure to air.

It has been determined that medical devices prepared according to the present application can be stored for several months without any loss of efficacy; the stored devices maintain the antimicrobial properties.

Specific examples of activating agents for use in the present application include reducing agents such as ascorbic acid, ferrous ions, and other reducing agents. Examples of ferrous ions include ferrous salts, such as ferrous gluconate.

As noted above, the organic dye can be selected among: methylene blue and its analogues, toluidine blue, methylene violet, azure A, azure B, azure C, brilliant cresol blue, thionin, methylene green, bromcresol green, gentian violet, acridine orange, brilliant green, acridine yellow, quinacrine, trypan blue and trypan red, or combinations of these compounds. In one embodiment, the dye selected for use is a dye of the phenothiazine class. Methylene blue is a water-soluble phenothiazine dye. Methylene blue collectively with other dyes from this family, such as toluidine blue and methylene violet, are effective inactivators of pathogenic organisms including viruses, bacteria, and yeast in skin lesions, especially when photo-activated on skin lesions (24). Both of these organic dyes also exhibit sufficient bactericidal potency in the dark. These dyes are to some extent amphipathic and cationic. Consequently, they contain a hydrophobic portion that can interact preferentially with lipids or other hydrophobic substances and a positively charged portion that interacts with water or negatively charged surfaces. While it is not intended to limit the subject matter described and claimed herein by any theory whereby it achieves its advantageous result, it is believed that these dyes, driven by electrostatic attraction to the negatively charged cell membranes of microbial targets, enter the membranes, form new channels and pores, and change the permeability that eventually can kill the microbes. It is thought that these dyes can interfere with the vital intracellular reactions involving oxidation and reduction such as conversion of NAD(P)H to NAD(P) and vice-versa.

In one form of impregnating a paraben free polymeric material with the methylene blue, two “activators”, ascorbic acid and ferrous gluconate, are used in a similar range of concentration. In experimental work involving these activators, ascorbic acid appeared to react faster and provide more reproducible results. Many intermediate species are created during the oxidation-reduction process by methylene blue after activation by ascorbic acid, and these intermediates can help to impregnate the matrix of the plastic materials. From the clinical results, it appeared that activation of methylene blue by either ascorbic acid or ferrous gluconate afforded nearly identical antibacterial properties to the treated plastic material. In another form, the methylene blue is activated with 2% ascorbic acid immediately before starting impregnation of the paraben treated polymeric material.

Light activation of the treated material may be advantageous for imparting antiviral and enhanced antibacterial activity. The rate of bactericidal activity can be enhanced by room light, which penetrates the external tubing of the catheter. Shining a very bright light down the lumen of a CVC catheter may also further increase bactericidal action. It is thought that methylene blue can transfer energy that it picks up from the light to molecular oxygen, so oxygen in the blood might have an effect similar to light. The singlet oxygen, which is formed, can mediate nucleic acid damage, principally at guanosine sites in the DNA or RNA backbone, and cause genetic sterilization. It is also believed that application of methylene blue or toluidine blue as a long-term impregnating compound for CVC catheters does not require light activation to be effective. The treated material exhibits sufficient bactericidal activity in the dark. Light was not completely excluded from the above-described experiments; however, incubation was performed in the dark, plating of bacteria in petri dishes was performed in low-level room light, and the cultures were maintained in complete darkness. The molecular structure of these dyes, positive charge and possible dimerization, may allow methylene blue and similar dyes to kill bacteria by changing the transmembrane permeability of microbes. This function does not require activation by light. If the concentration of methylene blue increases inside the bacteria cell, other factors result in damage of bacteria, including changes in the redox potential due to excited states of the dye, quantum yield of the triplet-state formation, and quantum yield of singlet oxygen formation.

In use, the medical devices according to the present application are preferably sterilized before implantation into the patient. Upon implantation according to standard surgical procedures, it can be observed that there may be a slight discoloration around the site of implantation. Additionally, contacting the polymeric material with normal saline or other solvents may induce an added release of the organic dye and/or paraben(s) from the polymeric material. For example, in catheter 12 illustrated in FIG. 1, wiping the hubs 18 and 20 and puncture caps 22 and 24 with BETADINE® and/or an alcohol pad may cause discoloration of the respective pads. Additionally the organic dye compound or paraben(s) may leach into any lock solution in the catheter lumen. However, the catheter as illustrated in FIG. 1 can be used according to standard medical practices. Furthermore, lock solutions for these catheters can include normal saline, antimicrobial/antibiotic compositions, and anticoagulants, such as heparin or a citrate composition as has been used in the past.

For the purpose of promoting further understanding and appreciation of the present application and its advantages, the following Examples are provided. It will be understood, however, that these Examples are illustrative and not limiting in any fashion.

### EXAMPLE 1

### Methylene Blue Impregnation

In one study relating to the present application, two different plastic materials that are currently used for CVC catheter production were impregnated with methylene blue. The first polymer was EG-85A from the Tecoflex family of aliphatic polyurethanes (EG) and the second was PC-3575A from the Carbothane family of aliphatic polyurethane/polycarbonates (PC). Neither of the plastics tested were observed to become impregnated by methylene blue when exposed for up to 24 hours to 0.1 to 0.5 % of methylene blue solution in the range pH between 4 to 9 units. Fluorescent light did not help to impregnate methylene blue on either plastic. It has been discovered, however, that the rate of plastic impregnation with methylene blue is significantly increased by employing an activating agent (or “activator”) such as, for example, a reducing agent. Examples of reducing agents include ascorbic acid or a soluble form of ferrous ion (for example, ferrous gluconate).

Ascorbic acid is a powerful reductant and free radical scavenger. Kinetics of oxidation of ascorbic acid by methylene blue in acid media revealed many steps and several intermediate active species of methylene blue and ascorbic acid (25-27). It is believed that at least some of these reactive intermediates can activate the carbon atoms of the polymeric matrix. This process in turn allows binding of methylene blue to the polymer chains. Experiments performed in 0.24 M citrate buffer at pH 4.5 with 0.1% methylene blue and 1%-2% of ascorbic acid or ferrous gluconate permitted impregnation of both polymers within a few hours at ambient temperature. It was observed that the organic dye compound penetrated deeper into polyurethane than into polyurethane/polycarbonate; however, the polyurethane/polycarbonate was impregnated sufficiently to penetrate the surface of the plastic material.

The data from the two different materials revealed that the active form of methylene blue, which is bound to a matrix, is probably the leuco-form. When exposed to air after washing the excess of reagents, the bound methylene blue is gradually oxidized to oxy form. The properties of the absorbed layer, such as thickness, dimerization, and hydrophilicity, may be controlled by proper selection of dye and activator concentration used in this composition and time of reaction. The bonding is strong but not so much as to prevent a small amount of leaching in aqueous solutions or saline. This process can be observed to occur over weeks and months and may have great advantages including bactericidal activity in the biofilm and surrounding tissues or clots.

### EXAMPLE 2

### Antimicrobial Evaluation of Methylene Blue Impregnated Polymeric Material

The polyurethane- and polyurethane/polycarbonate-impregnated plastic materials were tested against three strains of bacteria: E. coli 25922, S. epidermidis 49134, and S. aureus 29213. The impregnated plastic materials were prepared as described above. Inoculum of each bacterium was prepared from a single colony in 15 ml of trypticase-soy (TS) medium overnight at 37° C. Fifteen μL of inoculum was added to 15 ml of fresh medium and incubated for a few hours (5-6 h). Seventy-five (75) μL of 100 times diluted fresh culture was then used in experiments with samples of each of the impregnated plastic material. A culture of the selected strain was placed on the bottom of a petri dish and covered by an approximately 2.25 cm² sheet of the impregnated plastic material. The sheet was pressed firmly against the agar to get a thin and equal layer of culture medium contacting the sheet. A small container with 1 ml of water was placed in the upturned lid of the petri dish. The petri dish with the inoculum and plastic sheet were then inverted and mated with the lid. The lid and petri dish were sealed tightly by coating the rim of either the lid or the dish with petroleum jelly. The dish was then placed upside down in an incubator maintained at 32° C. for 24 hours.

Simultaneously, controls were created for the experiment. Untreated polyurethane and polyurethane/polycarbonate sheets (about.2.25 cm²) were placed in separate petri dishes to culture suspension. Another control was 75 μL of bacteria culture placed in the petri dish as a “hanging drop” without any plastic sheet material. As described above, the dishes were mated to their lids, which contained 1 ml of water, sealed, and placed in the incubator.

After approximately 24 hours of incubation at 32° C., 15 μL of bacterial cultures from each dish were mixed with 15 ml of fresh TS. Resulting suspensions were used as “stock solutions”. The stock solutions were further diluted 10², 10⁴ and 10⁶ fold. One ml of each dilution was spread on a separate TS agar plate incubated overnight at 37° C. for colonies calculation.

All three tested strains of bacteria revealed dramatic inhibition of culture growth after contacting methylene blue-impregnated plastics sheets. There appeared to be no significant differences between the polyurethane or polyurethane/polycarbonate-impregnated materials. The loglo CFU reduction after 24 hours of incubation is a range of 7 to 6. The residual bacterial activity was very low. Bacteria colonies were detected in only two of the 1 ml of stock solutions when incubated on the agar plates.

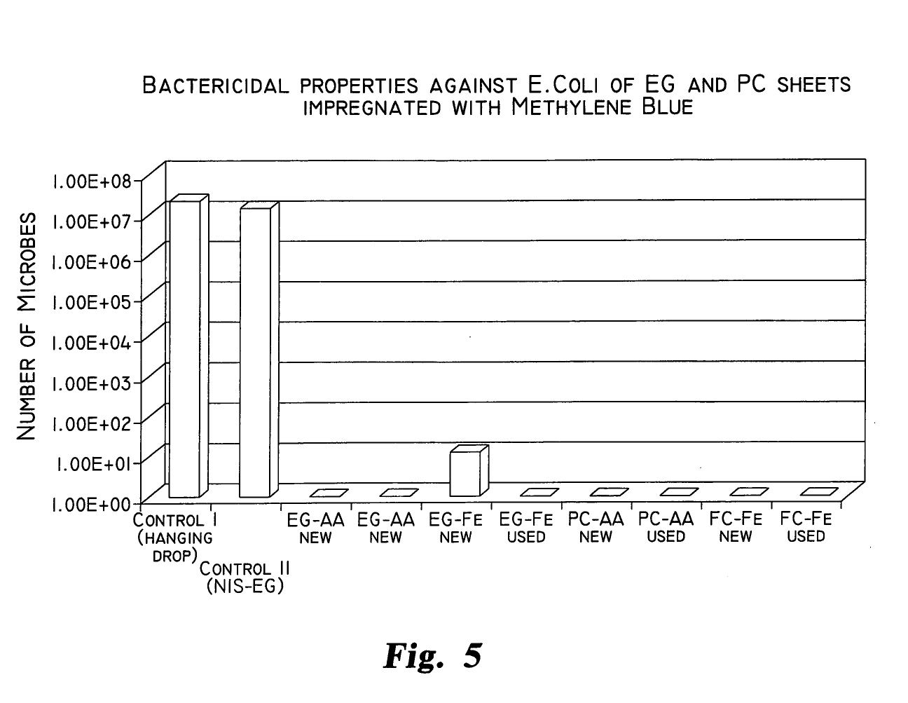

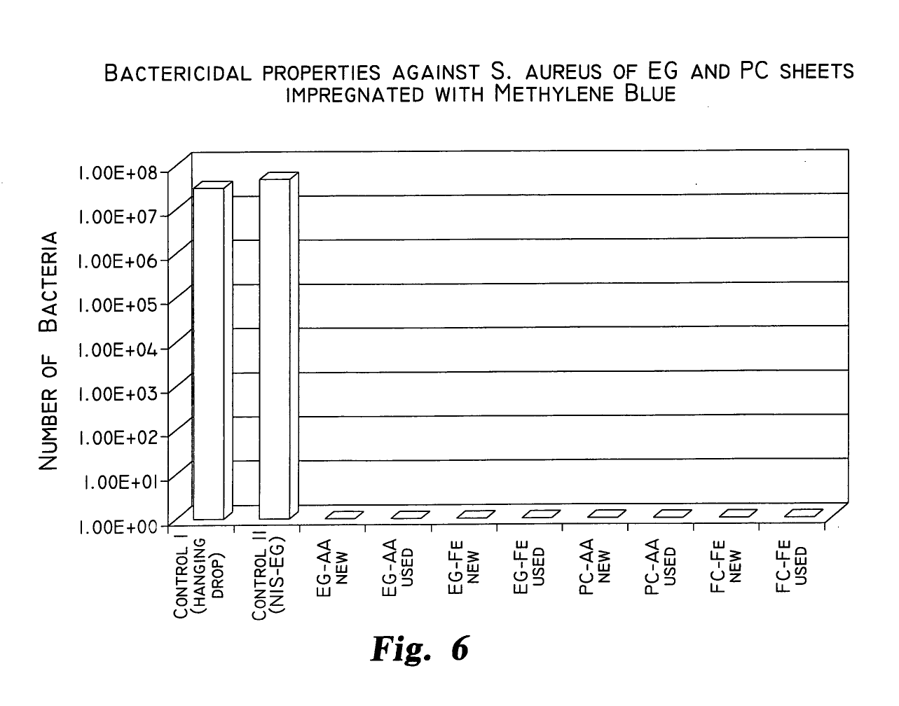

FIG. 5 is a graph illustrating E. coli bacterial concentration in the control samples and in the media in contact with the impregnated polyurethane sheets. The concentration of E. coli bacteria in each of the controls was 10⁷ to 10⁸ bacteria per ml. The bacterial concentration was nearly zero or non-detectable on the media in contact with the four methylene blue-impregnated membranes: EG-AA (polyurethane with ascorbic acid as the reducing agent), EG-Fe (polyurethane with ferrous ion as the reducing agent), PC-AA (polyurethane/polycarbonate with ascorbic acid as the reducing agent), and PC-Fe (polyurethane/polycarbonate with ferrous ion as the reducing agent). In separate experiments, samples of each type of membrane were stored dry for one month and re-tested as above described. For all of the impregnated sheets, whether activated by ascorbic acid or ferrous ion, the results of the later tests were the same as if the impregnated plastics were freshly prepared. Each treated sheet allowed nearly zero bacteria growth in the contacting media.

FIG. 6 is a graph illustrating the results of experiments as described above except using S. aureus as the bacteria strain. Results are substantially the same as found for E. coli above. For all of the impregnated sheets, whether activated by ascorbic acid or ferrous ion, the results were the same: nearly zero bacteria in the contacting fluid. As before in separate experiments, samples of the impregnated sheets were stored dry for one month and retested. Again, the test results were essentially identical with those previously obtained for the freshly prepared impregnated sheets.

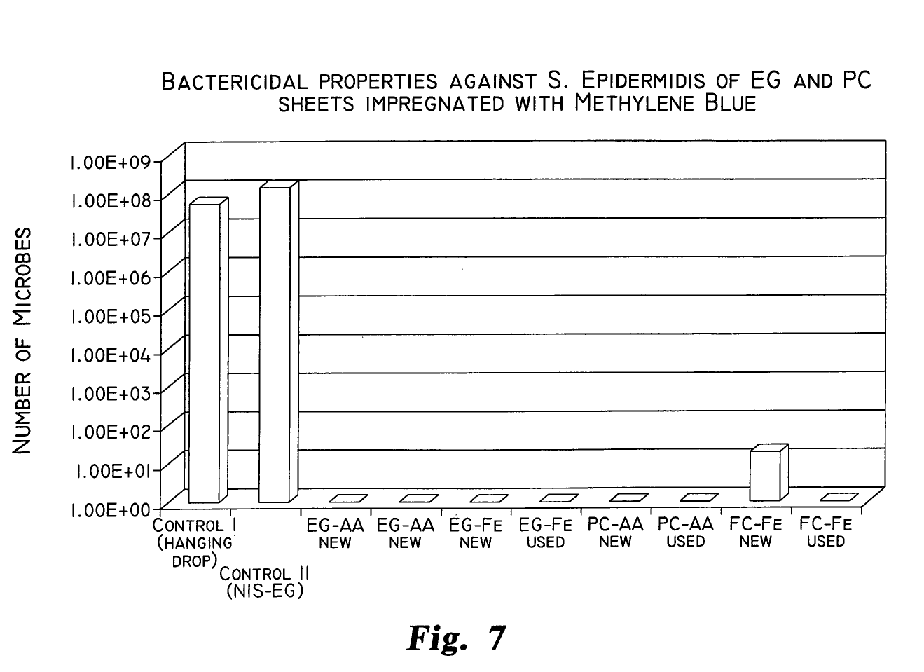

FIG. 7 is a graph illustrating the results of experiments as described above using S. epidermidis as the bacteria strain. As can be seen from the graph, the results are substantially the same as those obtained for the E. coli and S. aureus strains. For all of the impregnated plastic sheets, whether activated by ascorbic acid or ferrous ion, the results were the same: nearly zero bacteria growth in the contacting media. As before, samples of the impregnated sheets were stored for one month and retested. The results again were essentially identical to those obtained with the freshly prepared impregnated sheets.

### EXAMPLE 3

Comparison of Polymers Treated with a Dye in Combination with an Activating Agent

A series of polymeric tubing were treated according to the present application as described above in Example 1, as follows: each tubing was immersed in a 0.1% aqueous solution of methylene blue and 2% solution of ascorbic acid in 0.24 M citrate buffer (ph 6) for two hours, then removed, washed with saline and dried.

For comparison, the same type of polymeric tubing was treated using different methods of treatment. A set of the tubing was treated: each tubing was immersed in a 1% aqueous solution of methylene blue for 24 hours, then removed, washed with saline and dried.

Another set of the tubing was treated with a mixture of methylene blue and N-methylglucamine as follows: each tubing was immersed in a 1% aqueous solution of N-methylglucamine for 24 hours, washed with saline and dried and immersed in 1% aqueous solution of methylene blue for 24 hours, then removed, washed with saline and dried.

The results of these experiments are listed in Table 1 below.

TABLE 1

| | Methods | | |
|---|---|---|---|
| | 1% | 1% N | 2% Ascorbic |
| | Methylene | methylglucamine | Acid and 0.1% |
| | Blue | (24 h), then 1% | Methylene |
| Material | (24 hr) | Methylene Blue (24 h) | Blue (2 hr) |
| Polyurethane | | Very light blue on | Strong dark blue |
| | | he surface only | throughout material |
| Polyurethane/ | Slightly | Very little of white | Strong dark blue |
| polycarbonate | dirty | on the surface | throughout material |
| | white on | | |
| | the | | |
| | surface | | |
| Silicone | Very light | Very light green on | Strong dark blue |
| (transparent) | green | the surface | throughout material |
| | on the | | |
| | surface | | |
| Silicone | Tint of | Tint of green on | Dark blue |
| (opaque) | green on | the white surface | throughout material |
| | the white | | |
| | surface | | |

### EXAMPLE 4

Impregnation of Polymeric Materials with Parabens

One inch polycarbonate catheter pieces including a surface area of about 4.64 cm² were impregnated with methyl paraben and propyl paraben. A solution of 100% 1,2-propanediol was prepared with 9% methyl paraben and 2% propyl paraben. Pairs of the one inch catheter pieces were placed into three 25 ml flasks including 10 ml of the 1,2-propanediol and paraben solution. The flasks including the catheter pieces were placed on a shaker at 220 rpm and 27° C. for two, four, or nine hour time periods. At the end of each time period, the catheter pieces were removed, rinsed with distilled water, and dried.

Desorption analysis of the paraben impregnated catheter pieces was performed in 0.24 M sodium citrate with a pH of 6.2. The total amount of either methyl paraben or propyl paraben released from the catheter pieces was calculated using HPLC analysis performed with a Waters Alliance 2690 including a 996 Photodiode Array Detector. Each calculation used a solution of HPLC grade H₂O, methanol (MeOH), and acetonitrile (CAN) which were pre-filtered through a Millipore 0.45 μm nylon filter before use. Trifluoracetic acid (TFA) was added to H₂O and acetonitrile (ACN) to 0.1%. A Waters Symmetry column (C8 3.9×150 mm, 5 μm) was applied with a Waters guard column (Waters, Sentry Guard column, Nova-Pak C18, 60A, 4 μm 3.9×20 mm).

A gradient of 67% H₂O/33% ACN was used for 6.5 min, ramped to 45 %/55% from 6.5 to 7.0 min, and kept at 45%/55% until 15.0 min, at 15.0 min the concentration reverted to 67%/33%, and the system was run until 18 min. Injection volume for each sample was 10 μl and samples and column were run at ambient temperature.

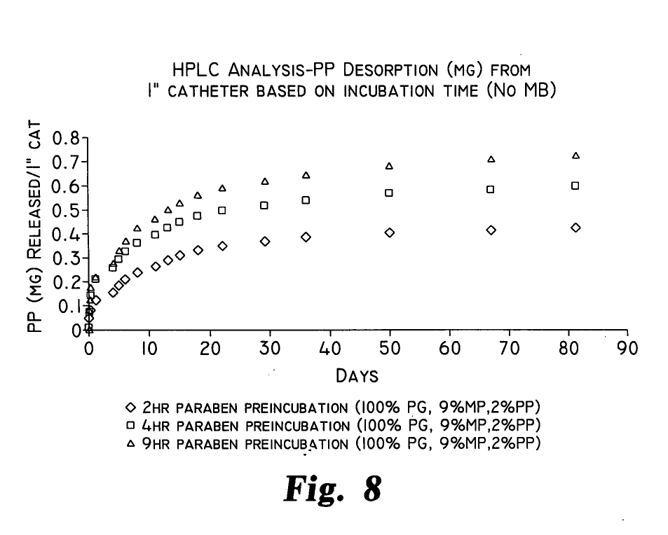

Table 2 includes the graphical data represented in FIG. 8 and associated with the desorption of propyl paraben from the paraben impregnated catheter pieces prepared as discussed above. Again, the samples were impregnated only with parabens and desorbed in 10 ml 0.24 M Na-citrate, pH 6.2 over time.

TABLE 2
Table of FIG. 8. PP Released (mg)/1″ piece of catheter

| | Treatment | | |
|---|---|---|---|
| | 2 hrs | | |
| | (100% PG, | 4 hrs (100% PG, | 9 hrs (100% PG, |
| Time | 9% MP, 2% PP | 9% MP, 2% PP) | 9% MP, 2% PP) |
| (hours*/days) | Total PP released (mg)/1″ catheter | | |
| 1* | 0.048 | 0.007 | 0.082 |
| 3* | 0.081 | 0.069 | 0.124 |
| 7* | 0.121 | 0.138 | 0.175 |
| 24* | 0.121 | 0.208 | 0.221 |
| 4 | 0.153 | 0.254 | 0.279 |
| 5 | 0.182 | 0.293 | 0.331 |
| 6 | 0.209 | 0.326 | 0.375 |
| 8 | 0.239 | 0.362 | 0.422 |
| 11 | 0.264 | 0.393 | 0.463 |
| 13 | 0.288 | 0.424 | 0.5 |
| 15 | 0.311 | 0.45 | 0.533 |
| 18 | 0.332 | 0.476 | 0.565 |
| 22 | 0.352 | 0.497 | 0.594 |
| 29 | 0.37 | 0.518 | 0.622 |
| 36 | 0.387 | 0.539 | 0.65 |
| 50 | 0.404 | 0.569 | 0.687 |
| 67 | 0.417 | 0.585 | 0.708 |
| 81 | 0.429 | 0.6 | 0.727 |

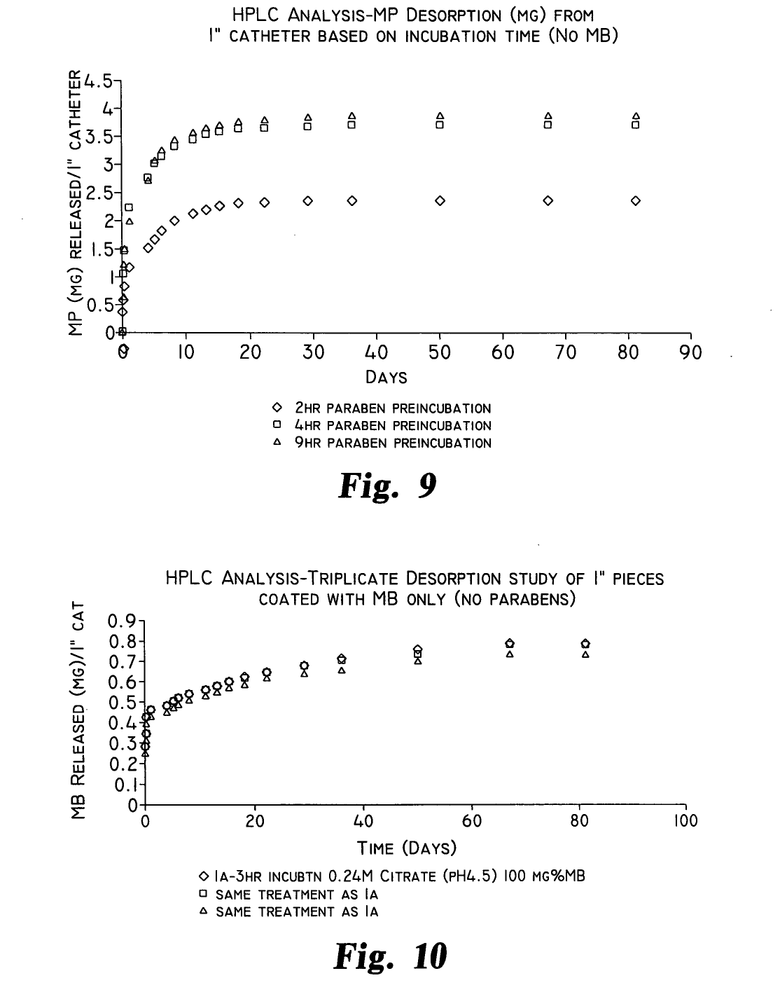

Table 3 includes the graphical data represented in FIG. 9 and associated with the desorption of propyl paraben from the paraben impregnated catheter pieces prepared as discussed above. Again, the samples were impregnated only with parabens and desorbed in 10 ml 0.24 M Na-citrate, pH 6.2 over time.

TABLE 3
Table of FIG. 9. MP Released (mg)/1″ piece of catheter

| | Treatment | | |
|---|---|---|---|
| | 2 hrs | | |
| | (100% PG, | 4 hrs (100% PG, | 9 hrs (100% PG, |
| Time | 9% MP, 2% PP) | 9% MP, 2% PP) | 9% MP, 2% PP) |
| (hours*/days) | Total MP released (mg)/1″ catheter | | |
| 1* | 0.361 | 0.603 | 0.67 |
| 3* | 0.577 | 1.04 | 1.18 |
| 7* | 0.84 | 1.472 | 1.504 |
| 24* | 1.17 | 2.223 | 1.993 |
| 4 | 1.519 | 2.774 | 2.725 |
| 5 | 1.685 | 3.01 | 3.082 |
| 6 | 1.826 | 3.146 | 3.27 |
| 8 | 2.002 | 3.324 | 3.456 |
| 11 | 2.129 | 3.449 | 3.593 |
| 13 | 2.208 | 3.536 | 3.676 |
| 15 | 2.281 | 3.597 | 3.734 |
| 18 | 2.325 | 3.646 | 3.788 |
| 22 | 2.356 | 3.676 | 3.832 |
| 29 | 2.377 | 3.701 | 3.872 |
| 36 | 2.392 | 3.722 | 3.912 |
| 50 | 2.402 | 3.74 | 3.944 |
| 67 | 2.409 | 3.749 | 3.958 |
| 81 | 2.413 | 3.755 | 3.967 |

### EXAMPLE 5

Impregnation of Polymeric Materials with Methylene Blue

In another form of the present application, one inch polycarbonate catheter pieces including a surface area of about 4.64 cm² were impregnated with methylene blue. A solution of 0.24 M sodium citrate buffer pH 4.5 was prepared with 100 mg % methylene blue activated by 2% L-ascorbic acid immediately beforehand. Catheter pieces were placed in flasks containing the solution and the flasks were placed on a shaker at 220 rpm and 27° C. for 3 hours.

Desorption analysis of the methylene blue impregnated catheter pieces was performed in a 0.9% solution of saline. The total amount of methylene blue released from the catheter pieces was calculated using HPLC analysis performed with a Waters Alliance 2690 including a 996 Photodiode Array Detector according to conditions in Example 4. The results of the HPLC analysis corresponding to the desorption of methylene blue from the methylene blue impregnated polymeric material are set forth in the graph of FIG. 10.

### EXAMPLE 6

Impregnation of Polymeric Material with Parabens and Methylene Blue

One inch polycarbonate catheter pieces including a surface area of about 4.64 cm² were impregnated with methyl paraben and propyl paraben. A solution of 100% 1,2-propanediol was prepared with 9% methyl paraben and 2% propyl paraben. Pairs of the one inch catheter pieces were placed into three 25 ml flasks including 10 ml of parabens solution. The flasks were placed on a shaker at 220 rpm and 27° C. for two, four, or nine hours. At the end of each time period, the catheter pieces were removed, rinsed with distilled water, and dried.

The catheter pieces were then impregnated with methylene blue. A solution of 0.24 M sodium citrate buffer with a pH of 4.5 was prepared with 100 mg % methylene blue activated by 2% L-ascorbic acid immediately beforehand. Catheter pieces were placed in flasks containing the solution and the flasks were placed on a shaker at 220 rpm and 27° C. for 3 hours. Desorption analysis of the parabens and methylene blue impregnated catheter pieces was performed in a 0.9% solution of saline according to the method described earlier.

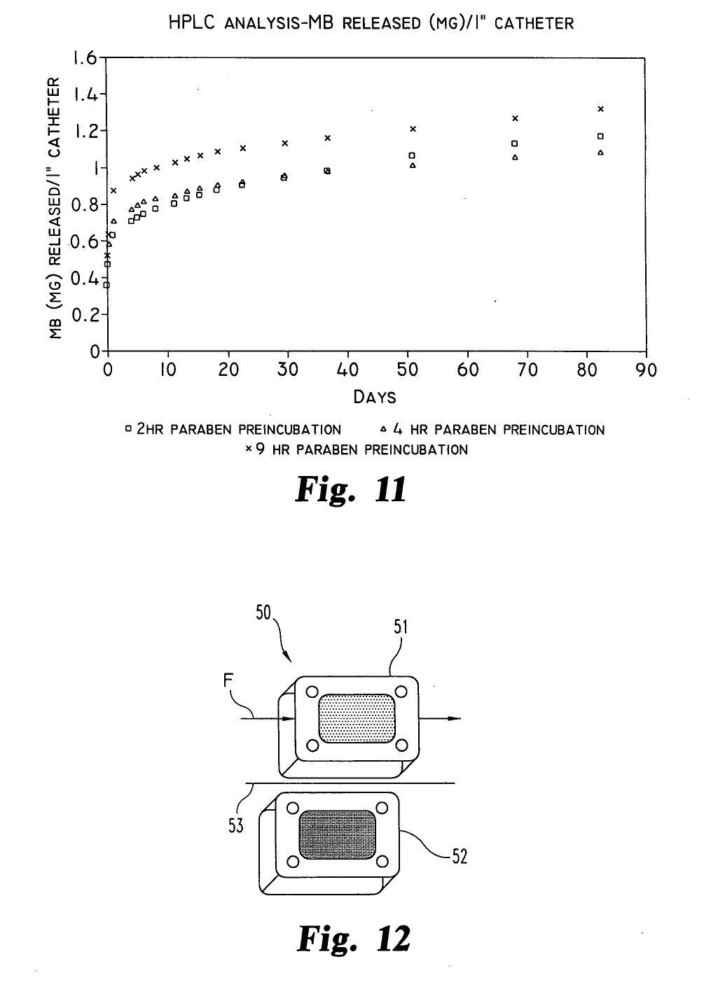

The results of the HPLC analysis of the release of methylene blue from the methylene blue and parabens impregnated polymeric material are set forth in the graph illustrated in FIG. 11. UV spectral analysis was comparable to HPLC for methylene blue, but not with methyl paraben or propyl paraben due to their overlapping spectral data in and around 255 nm.

The following conclusions are drawn from HPLC results. By the end of the study, nearly 3 months, methyl paraben and propyl paraben showed negligible desorption (FIGS. 8 and 9). Methyl paraben demonstrated a significant release through the first 10 days of the study, a smaller amount until 20 days, and little release to negligible release afterwards (Table 3). Propyl paraben demonstrated significant release until 20 days, a smaller amount until 50 days, and a less significant amount after-that (Table 2).

Methylene blue catheters pretreated with parabens (FIG. 11) showed a small amount of methylene blue still being released at the conclusion of the 81^{st} day of trial while catheters treated only with methylene blue showed a negligible release during the last 20 days of the experiment (FIG. 10). Catheters preincubated with parabens before being contacted with methylene blue released a greater amount of methylene blue over a longer duration of time than catheters incubated with methylene blue alone (see FIGS. 10 and 11). Catheters preincubated with parabens showed a significant release of methylene blue through the first 10 days, showed a smaller release until day 68, and a less substantial amount following day 68. Although it is not intended that the present application be limited by any theory whereby it achieves its advantageous results, it is believed that the impregnation of the polymeric material with methyl paraben and propyl paraben prior to methylene blue impregnation increases the amount methylene blue impregnated into the material and extends the release of an effective amount of methylene blue from the polymeric material for greater periods of time. It is contemplated, as would be appreciated by one having skill in the art, that one or both of the loading and release of the methylene blue or other organic dye may be influenced by any one or more of: changing pH levels; changing reaction temperatures; changing the duration of impregnation; changing concentrations of impregnation materials; changing the types of impregnation materials; changing the polymeric material; utilizing a viscosifying agent; and altering the solvent of the impregnation solutions, just to name a few possibilites.

### EXAMPLE 7

Study of Total Methylene Blue Loaded Onto and Released from Polycarbonate Discs and Catheters

An experiment was performed in order to determine the total amount of methylene blue that was loaded onto a polycarbonate disc in comparison to a polycarbonate catheter. The discs were 1.27 cm or 0.5 inches in diameter and included a surface area of 2.53 cm² and a thickness of 0.60 mm. The catheter pieces were 1″ long and included a surface area of 4.64 cm² and a thickness of 0.51 mm. A 160 ml solution of 0.24 M sodium citrate was prepared into which 0.1% or 0.187 g of methylene blue was added. Then, 2%, or 3.2 g of ascorbic acid, was added to the solution and mixed for 1-2 minutes and 10 ml of the solution was placed into 25 ml flasks. The discs and catheter pieces were rinsed and placed into the 25 ml flasks of solution and placed on a shaker at 220 rpm at 37° C. for three hours. The catheter pieces and discs were removed, rinsed with distilled water, and dried. The catheter pieces and discs were desorbed in 20 ml of MeOH (w/0.1% TFA) and placed on the shaker until the membranes appeared whitish in color. Appropriate dilutions were made and the UV absorbance was measured at 662 nm. The methylene blue concentration was calculated based on a standard curve generated in a similar manner. The results are set forth below in Table 4 and 5.

TABLE 4
Amount MB released/cm² of flat disc

| | | | | Amt MB | | |
|---|---|---|---|---|---|---|
| | | | | (mg) | | |
| | | | Average | released | | |
| | | | amount | per square | | Average |
| | | | (mg) | cm (mg/ | | ug/cm² |
| Disc | Paraben | MB | released | 2.53 cm²) | | MB |
| # | Treatment | Treatment | per disc | on disc | ug/cm² | released |
| 1 | NO | 3 hrs 0.24M | 4.94 | 1.95 | 1954.1 | 1942.8 |
| 2 | Parabens | Citrate | 4.87 | 1.92 | 1923.6 | |
| 3 | | Buffer, | 4.88 | 1.93 | 1929.0 | |
| 4 | | 4.5 pH, | 4.97 | 1.96 | 1964.3 | |
| | | 100 mg % | | | | |
| | | MB, 2% AA | | | | |

TABLE 5
Amount MB released/cm² of catheter

| | | | | | % MB released |
|---|---|---|---|---|---|
| | | | | | from catheter in |
| | | mg released | | ug released | saline desorption/ |
| | | based on 1″ of | mg released per cm² of | per cm² of | total released in |
| Paraben treatment | MB treatment | catheter | catheter | catheter | MeOH (0.1% TFA) |
| No Parabens | 3 hrs 0.24 M | 1.32 | 0.284 | 284.5 | 58.8 |
| | Citrate buffer, | | | | |
| | 4.5 pH, | | | | |
| 2 hrs- 100% PG, | 3 hrs 0.24 M | 1.65 | 0.356 | 356.3 | 73.2 |
| 9% MP, 2% PP | Citrate buffer, | | | | |
| | 4.5 pH, | | | | |
| | 100 mg % MB, | | | | |
| 4 hrs- 100% PG, | 3 hrs 0.24 M | 1.71 | 0.368 | 368.5 | 65.5 |
| 9% MP, 2% PP | Citrate buffer, | | | | |
| | 4.5 pH, | | | | |
| | 100 mg % MB, | | | | |
| 9 hrs- 100% PG, | 3 hrs 0.24 M | 1.78 | 0.384 | 383.6 | 76.4 |
| 9% MP, 2% PP | Citrate buffer, | | | | |
| | 4.5 pH, | | | | |
| | 100 mg % MB, | | | | |
| | 2% AA | | | | |

As indicated in Tables 4 and 5 above, the flat discs displayed a greater total of sorption and desorption of methylene blue per cm² than did catheters by a factor of about ˜6.8. Although it is not intended that the present application be limited by any theory whereby it achieves its advantageous results, it is believed that this is likely a combination of three factors. First, the disc has a greater thickness compared to the catheter (0.51 mm to 0.60 mm), allowing more methylene blue to penetrate and bind the polymer. Secondly, there is a greater movement of the activated solution passed over the surface area of the flat disc than over that of the catheter, due to resistance of solution through the narrow hole (≈2.4 mm) in the membrane. And finally, the catheter has a smoother finish, evident by eye, compared to the rougher surface of the membrane, which could allow for greater sorption onto the flat discs.

A general observation was noticed that as the length of treatment of a catheter with parabens increased before being impregnated with methylene blue, the amount of methylene blue released from the polymeric material also increased.

The compound on the membrane not released was bound more permanently and could not be removed by MeOH (0.1% TFA) and the resultant light green color of the membrane suggested a different chemical than the methylene blue was bound.

### EXAMPLE 8

### Testing of Membrane Reloading Via Perfusion Chamber

An experiment was performed to determine a method for perfusing methylene blue, methyl paraben, and propyl paraben through a polycarbonate membrane with causing only minimal changes to the strength and elasticity of the membrane. In FIG. 12, there is illustrated a perfusion chamber system 50 used during the experiment. System 50 includes an upper chamber 51 and a lower chamber 52 separated by a polycarbonate membrane 53 having a thickness of 0.60 mm. The upper and lower chambers 51, 52 are generally structured to hold 10.5 cm³ or 10.5 ml of fluid. The upper chamber 51 was connected to a peristaltic pump (not shown) and the lower chamber 52 was filled with distilled water. First and second solutions, respectively including the parabens and the methylene blue, were prepared in accordance with the method set forth in EXAMPLE 6 above. As best seen in Tables 6 and 7 below, the solutions were connected to the pump and passed through the first chamber 51 at a constant rate at 37° C. over various lengths of time.

Table 6 includes data obtained from HPLC analysis comparing the methyl paraben, propyl paraben, and methylene blue concentrations in the lower chamber 52. The parameters for the methyl and propyl paraben and methylene blue treatments are indicated in the left hand columns.

TABLE 6
Quantitative analysis of MP, PP, and MB concentrations
HPLC-sample of MB, MP, and PP in lower chamber
from perfusion through chamber

| | |
|---|---|
| Paraben Treatment/ | |
| time | MB treatment/time |

| | | | |
|---|---|---|---|
| 20% PG/ | ~9 hrs at | 0.24 M | ~10 days |
| 80% DI | 37 C. | NaCitrate, | w/MB |
| H2O | | pH4.5, | sol'n |
| (0.9% MP, | | 100 mg % | changed |
| 0.2% PP) | | MB, | every 1 |
| | | 2% AA at | day |
| | | 37 C. | |

| | Total mg MB in | |
|---|---|---|
| | 10.5 mL lower | |
| MB conc (mg/ml) | chamber | |
| 0.001 | 0.0105 | |
| | | ratio MP/ |
| | Total mg MP in | PP from |
| | 10.5 mL lower | this |
| MP Conc (mg/ml) | chamber | sample |
| 0.047 | 0.4935 | 4.7 |
| | Total mg PP in | |
| | 10.5 ml lower | |
| PP conc (mg/ml) | chamber | |
| 0.01 | 0.105 | |

Table 7 displays the qualitative differences of polycarbonate membranes undergoing various perfusion treatments with different parameters in regard to paraben and methylene blue impregnation. The parameters of each treatment are set forth toward the left hand side of the table.

TABLE 7
Qualitative Differences of Polycarbonate Membranes

| | | Time of | | Time of | | | | | |
|---|---|---|---|---|---|---|---|---|---|
| | Paraben | Paraben | MB | MB | | | | | |
| | treatment | Treatment 1 | Treatment 2 | Treatment | Temp | Strength | Elasticity | Texture | Color |
| Treatment 1 | 20% PG/ | 2 Days | 100 mg % MB, | 4.5 Days | 37° C. | Weaker/ | Stretchier | Slightly | Medium |
| | 80% DI | | 20% PG/ | | | Softer | | sticky | to Dark |
| | H2O | | 80% H2O | | | | | | Blue*\hat{ } |
| | (0.9% MP, | | (0.9% MP, | | | | | | |
| | 0.2% PP) | | 2% PP) | | | | | | |
| Treatment 2 | — | — | 100 mg % MB, | 4.5 Days | 37° C. | Weaker/ | Stretchier | Slightly | Medium |
| | | | 20% PG/ | | | Softer | | sticky | Blue*\hat{ } |
| | | | 80% H2O | | | (but | | | |
| | | | (0.9% MP, | | | stronger | | | |
| | | | 2% PP) | | | than 1) | | | |
| Treatment 3 | 20% PG/ | 48 hours | — | — | Ambient | Weaker | Stretchier | Sticky | White |
| | 80% DI | | | | | | | | (no |
| | H2O | | | | | | | | change) |
| | (0.9% MP, | | | | | | | | |
| | (0.2% PP) | | | | | | | | |
| Treatment 4 | — | — | 0.24M | 6 days, | 37 C. | | | smooth | dark |
| | | | NaCitrate, | 16.5 hours | | | | | blue, |
| | | | pH 4.5, | | | | | | med- |
| | | | 100 mg % | | | | | | dark |
| | | | MB, 2% AA | | | | | | blue |
| Treatment 5 | 20% PG/ | 41.5 hrs | — | — | 37 | Slightly | Slightly | smooth | White |
| | 80% DI | | — | — | | weaker | Stretchier | | (no |
| | H2O | | | | | | | | change) |
| | (0.9% MP, | | | | | | | | |
| | (0.2% PP) | | | | | | | | |
| Treatment 6 | 20% PG/ | ~9 hours | 0.24M | >2 Weeks | 37 C. | | Slightly | smooth | Dark, |
| | 80% DI | | NaCitrate, | | | | Stretchier | | Dark |
| | H2O | | pH 4.5, | | | | | | blue on |
| | (0.9% MP, | | 100 mg % | | | | | | top, dark |
| | 0.2% PP) | | MB, 2% AA | | | | | | blue on |
| | | | | | | | | | bottom |

The results of this experiment indicate that methyl paraben and propyl paraben could be perfused through the membrane 53 and detected in the lower chamber 52 within two hours, causing little qualitative change in membrane elasticity. Methylene blue took several days to perfuse through the membrane 53 (˜10 days). Methylene blue would not perfuse through membrane with only 1-2-propanediol (in absence of Citrate and activation by AA) after 4.5 days, and 1,2-propanediol caused significant damage to the membrane, making it noticeably weaker and more elastic (See for example, Table 7, treatment 1).

As seen in Table 6, methyl paraben and propyl paraben perfused the membrane 53 in a much shorter time span and in greater concentration than methylene blue. There was a 4.5 times higher concentration of methyl paraben compared to propyl paraben in the 1,2-propanediol perfusion solution. Methyl paraben and propyl paraben perfused the membrane at approximately the concentration they were in solution, with methyl paraben being 4.7 times greater (Table 6). Also significant in Table 6 was the observation that methyl paraben and propyl paraben were released at a value of 0.047 mg/ml and 0.01 respectively; values great enough to act as an antimicrobial agent. However, the concentration of methylene blue was not significant, even after 10 days of flow by activated solution. However, the purpose of the study was not to maximize methylene blue permeation.

In specific regard to Treatment 1 in Table 7, it is believed that the color of the polymeric membrane may be accounted for due to preincubation of parabens which has been seen in the previous studies (EXAMPLE 6) to load and release more methylene blue than impregnation with methylene blue alone. It is also possible that the color may be accounted for due to the organization of the chambers. In regard to both Treatments 1 and 2, it was noticeable that even after 4.5 days, methylene blue perfusion through the membrane to the lower chamber was minimal. To that regard, it is believed that activation is required to more efficiently transfer methylene blue through the polycarbonate membrane. The destruction of the strength of the polycarbonate membrane and the increased elasticity thereof were both seen greatly due to the presence of 1,2-propanediol for several days.

As seen in the HPLC chromatograms, both catheter desorption studies and membrane perfusion studies demonstrated a substantial peak prior to methylene blue which was negligible in the methylene blue standards, likely as a result of a reaction with citrate and/or ascorbic acid. This should be further investigated by mass spectroscopy (MS) or another technique.

The present application contemplates modifications as would occur to those skilled in the art. It is also contemplated that processes embodied in the present application can be altered or added to other processes as would occur to those skilled in the art without departing from the spirit of the present application. All publications, patents, and patent applications cited in this specification are herein incorporated by reference as if each individual publication, patent, or patent application was specifically and individually indicated to be incorporated by reference and set forth in its entirety herein.

Further, any theory of operation, proof, or finding stated herein is meant to ffurther enhance understanding of the present invention and is not intended to make the scope of the present invention dependent upon such theory, proof, or finding.

While the invention has been illustrated and described in detail in the drawings and foregoing description, the same is considered to be illustrative and not restrictive in character, it is understood that only the preferred embodiments have been shown and described and that all changes and modifications that come within the spirit of the invention are desired to be protected.

### REFERENCES

1. Maki D G. Infections caused by intravascular devices used for infusion therapy: pathogenesis, prevention, and management. In: Bisto A I, Waldvogel F A, eds. Infections associated with indwelling medical devices, 2nd edn. Washington, D.C.: American Society for Microbiology, 1994; 155-205.
2. Raad I I, Bodey G P. Infectious complications of iridwelling vascular catheters. Clin Infect Dis. 1992; 15: 197-210.
3. Maki D G. Infections due to infusion therapy. In:Bennett J V, Brachman P S, eds. Hospital Infections. Boston: Little Brown; 1992; 849-898.
4. Jarvis W R, Edwards J R, Culver D H, et al. Nosocomial infection rates in adult and pediatric intensive care units in the United States. Am J Med. 1991;9(suppl 3B): 185S-191S.
5. Collignon P J. Intravascular catheter associated sepsis: a common problem. The Australian Study on Intravascular Catheter Associated Sepsis. Med J Aust. 1994; 161: 374-378.
6. Maki D G, Cobb L, Garman J K, et al. An attachable silver impregnated cuff for prevention of infection with central venous catheters: a perspective randomized multicenter trial. Am J Med. 1988; 85: 307-314.
7. Heiselman D. Nosocomial bloodstream infections in the critically ill. JAMA 1994; 272:1819-1820.
8. Arnow P M, Quimosing E M, Beach M. Consequences of intravascular catheter sepsis. Clin Infect Dis. 1993; 16: 778-784.
9. Mermel L A, McCormick R D, Springman S R, Maki D G. The phatogenesis and epidemology of catheter-related infection with pulmanory artery Swan-Ganz catheters: a prospective study utilizing molecular subtyping. Am J Med. 1991; 91: 1975-2055.
10. Maki D G, Stolz S, Wheeler S, Mermel L A. A prospective, randomized trial of gauze and two polyurethane dressing for site care of pulmanory artery catheters: implication for catheter management. Crit Care Med. 1994; 22: 1729-1737.
11. Maki D G, Stolz S, Wheeler S, Mermel L A. Prevention of central venous catheter-related bloodstream infection by use an antiseptic-impregnated catheter. A randomized, controlled trial. Ann Intern Med. 1997; 127: 257-266.
12. Costerton J W, Irvin R T, Cheng K R. The bacterial glycocalyx in nature and disease. Annu Rev Microbial. 1981; 35: 299-324.
13. Pfaller M A, Messer S A, Hollis R J. Variation in DNA subtype, antifungal susceptibility and slime production among clinical isolates of Candida parapsilosis. Diagn Microbiol Infect Dis. 1995; 21: 9-14.
14. Sheth N K, Franson T R, Sohnle P G. Influence of bacterial adherence to intravascular catheters on in vitro antibiotic susceptibility. Lancet. 1985; 2: 1266-1268.
15. Farber B F, Kaplan M H, Clogstron A G. Staphylococcus epidermidis extracted slime inhibits the antimicrobial action of glycopeptide antibiotics. J Infect Dis. 1990; 161: 37-40.
16. Raad I I, Costerton J W, Sabharwal U, et al. Ultrastructural analysis of indwelling vascular catheters: a quantitative relationship between luminal colonization and duration of placement. J Infect Dis. 1993; 168: 400-407.
17. Raad I I, Luna M, Sayed-Ahmed M K, et al. The relationship between the thrombotic and infectious complications of central venous catheters. JAMA 1994; 271: 1014-1016.
18. Linares J, Sitges-Serra A, Garau J, et al. Phatogenesis of catheter sepsis: a prospective study with quantitative and semiquantitative cultures of catheter hub and segment. J. Clin Microbiol. 1983; 21: 357-360.
19. Salzman M B, Isenberg H D, Shapiro J F, et al. A prospective study of the catheter hub as the portal of entry for microorganisms causing catheter-related sepsis in neonants. J Infect Dis. 1993; 167: 487-490.
20. Stiges-Serra A, Puig P, Linares J, et al. Hub colonization as the initial step in an outbreak of catheter-related sepsis due to coagulase negative staphylococci during parenteral nutrition JPEN 1984; 8: 668-672.
21. Greco R S, Harvey R A. The role of antibiotics bonding in the prevention of vascular prosthetic infections. Ann Surg. 1982; 195: 168-171.
22. Harvey R A, Greco R S. The noncovalent bonding of antibiotics to a polytetrafluoroethylene benzalkonium graft. Ann Surg. 1981; 194: 642-647.
23. Sierdazki K, Roberts R B, Haber S w, Tomasz A. The development of vancomycin resistance in a patient with methicillin-resistant Staphylococcus aureus infection. N Engl J Med. 1999; 340: 517-523.
24. Wianwright M. Non-porphyrin photosensitizers in biomedicine. Chem Soc Rev. 1997; 25: 351-359.
25. Strizhak P E. Kinetics of oxidation of ascorbic acid by methylene blue in acid solutions. Theor Exper Chem. 1993; 29: 283-286.
26. Srtizhak P E. Effect of copper (II) ions on kinetics of ascorbic acid oxidation by methylene blue.
27. Khan M N, Sarwar A. The influence of transition metal ions on the kinetics of ascorbic acid oxidation by methylene blue in strongly acidic media. Turk J Chem. 2001; 25: 433-440.
28. Ash S R, Mankus R A, Sutton J M, Criswell R E, Crull C, Velasquez K, Smeltzer B, Ing T. Concentrated sodium citrate (23%) for catheter lock. Hemodialysis International 4:22-31, 2000.

What is claimed is:

1. A medical device for implantation into tissue of a patient or use in preparation of a fluid to be delivered to a patient, comprising a polymeric material impregnated with a paraben and an organic dye, wherein said paraben and said organic dye exhibit antibacterial activity and said polymeric material is effective to release at least one of said paraben and said organic dye from said polymeric material.

2. The device of claim 1, wherein said polymeric material is effective to release said organic dye.

3. The device of claim 1, wherein said polymeric material is effective to release said paraben.

4. The device of claim 1, wherein said polymeric material is impregnated with said organic dye subsequent to impregnation of said polymeric material with said paraben.

5. The device of claim 1, wherein said paraben and said organic dye are homogeneously distributed within the polymeric material.

6. The device of claim 1, wherein said at least one of said paraben and said organic dye is released from said polymeric material for at least one week.

7. The device of claim 1, wherein said at least one of said paraben and said organic dye is released from said polymeric material for at least two weeks.

8. The device of claim 1, wherein said at least one of said paraben and said organic dye is released from said polymeric material for at least one month in an amount sufficient to inhibit bacteria growth.

9. The device of claim 1, wherein said polymeric material comprises a polymer selected from the group consisting of: acrylics, polyacrylates, polymethacrylates, fluorocarbons, hydrogels, polyacetals, polyamides, polyurethane/polycarbonate, polyesters, poly(ether, ketones) (PEK), polyimides (nylons), polyolefins, polystyrene, polysulfones, polyurethanes, polyvinyl chloride (PVC), polycarbonate, silicone rubbers, polyethylene, polyurethane, latex, polyesters, poly(ethylene-terephthalat-e), and blends of these polymers.

10. The device of claim 1, wherein said polymeric material comprises a polymer selected from the group consisting of:.poly(amino acids), polyanhydrides, polycaprolactones, poly(lacti-glycolic acid), polyhydroxybutyrates, polyorthoesters, and blends of these polymers.

11. The device of claim 1, wherein said organic dye is selected from the group consisting of: methylene blue, toluidine blue, methylene violet, azure A, azure B, azure C, brilliant cresol blue, thionin, methylene green, bromcresol green, gentian violet, acridine orange, brilliant green, acridine yellow, quinacrine, trypan blue, trypan red and mixtures of these dyes.

12. The device of claim 1, wherein said polymeric material is impregnated with said organic dye in the presence of a reducing agent.

13. The device of claim 13, wherein said reducing agent is selected from the group consisting of: ascorbic acid and ferrous gluconate.

14. The device of claim 1, wherein said paraben is selected from the group consisting of: methyl paraben, ethyl paraben, propyl paraben, butyl paraben, isobutyl paraben, isopropyl paraben, and benzyl paraben.

15. The device of claim 1 comprising a catheter.

16. The device of claim 1, comprising a suture or a surgical staple.

17. The device of claim 1, comprising one or more fluid circuits within a dialysis machine and a water purifying system.

18. The device of claim 1, comprising an absorbent sponge.

19. A polymeric material for use in a medical device, said material comprising a paraben and an organic dye impregnated therein.

20. The polymeric material of claim 19, wherein said paraben is effective to control the impregnation of said organic dye into said material and the release of said organic dye from said material.

21. The polymeric material of claim 19, further being structured to release an effective amount of one or more of said paraben and said organic dye in an amount sufficient to inhibit bacteria growth.

22. The polymeric material of claim 19, further being structured for contact with an internal tissue or organ of an animal.

23. The polymeric material of claim 19, wherein said medical device is a catheter.

24. The polymeric material of claim 19, comprising a polymer selected from the group consisting of: acrylics, polyacrylates, polymethacrylates, fluorocarbons, hydrogels, polyacetals, polyamides, polyurethane/polycarbonate, polyesters, poly(ether, ketones) (PEK), polyimides (nylons), polyolefins, polystyrene, polysulfones, polyurethanes, polyvinyl chloride (PVC), polycarbonate, silicone rubbers, polyethylene, polyurethane, latex, polyesters, poly(ethylene-terephthalat-e), and blends of these polymers.

25. The polymeric material of claim 19, comprising a polymer selected from the group consisting of: poly(amino acids), polyanhydrides, polycaprolactones, poly(lacti-glycolic acid), polyhydroxybutyrates, polyorthoesters, and blends of these polymers.

26. The polymeric material of claim 19, wherein said organic dye is selected from the group consisting of: methylene blue, toluidine blue, methylene violet, azure A, azure B, azure C, brilliant cresol blue, thionin, methylene green, bromcresol green, gentian violet, acridine orange, brilliant green, acridine yellow, quinacrine, trypan blue, trypan red and mixtures of these dyes.

27. The polymeric material of claim 19, wherein said paraben is selected from the group consisting of: methyl paraben, ethyl paraben, propyl paraben, butyl paraben, isobutyl paraben, isopropyl paraben, and benzyl paraben.

28. A method of manufacturing polymeric material for a medical device, comprising:
contacting a polymeric material with a first liquid composition including a paraben to impregnate said polymeric material with said paraben, thereby providing a paraben impregnated polymeric material; and
contacting said paraben impregnated polymeric material with a second liquid composition including an organic dye to impregnate said paraben impregnated polymeric material with said organic dye, thereby providing a paraben and organic dye impregnated polymeric material.

29. The method of claim 28, wherein said first liquid composition includes methyl paraben and propyl paraben.

30. The method of claim 29, wherein said first liquid composition further includes 1,2-propanediol.

31. The method of claim 30, wherein said organic dye of said second liquid composition is methylene blue.

32. The method of claim 31, wherein said methylene blue has been activated in the presence of a reducing agent.

33. The method of claim 32, wherein said reducing agent is selected from the group consisting of: ascorbic acid and ferrous gluconate.

34. The method of claim 31, wherein said second liquid composition comprises a solvent selected from the group consisting of: water, an alcohol, tetrahydrofuran, acetone, and mixtures thereof.

35. The method of claim 34, wherein said second liquid composition further includes a sodium citrate buffer.

36. The method of claim 34, wherein said second liquid composition includes a pH of 4.5.

37. The method of claim 28, wherein said paraben is selected from the group consisting of: methyl paraben, ethyl paraben, propyl paraben, butyl paraben, isobutyl paraben, isopropyl paraben, and benzyl paraben.

38. The method of claim 28, wherein said organic dye is selected from the group consisting of: methylene blue and its analogues, toluidine blue, methylene violet, azure A, azure B, azure C, brilliant cresol blue, thionin, methylene green, bromcresol green, gentian violet, acridine orange, brilliant green, acridine yellow, quinacrine, trypan blue, trypan red and mixtures of these dyes.

39. The method of claim 28, wherein said polymeric material comprises a polymer selected from the group consisting of: acrylics, polyacrylates, polymethacrylates, fluorocarbons, hydrogels, polyacetals, polyamides, polyurethane/polycarbonate, polyesters, poly(ether, ketones) (PEK), polyimides (nylons), polyolefins, polystyrene, polysulfones, polyurethanes, polyvinyl chloride (PVC), polycarbonate, silicone rubbers, polyethylene, polyurethane, latex, polyesters, poly(ethylene-terephthalat-e), and blends of these polymers.

40. The method of claim 28, wherein said polymeric material comprises a polymer selected from the group consisting of: poly(amino acids), polyanhydrides, polycaprolactones, poly(lacti-glycolic acid), polyhydroxybutyrates, polyorthoesters, and blends of these polymers.

41. The method of claim 28, wherein contacting said polymeric material with said first liquid composition comprises immersing said polymeric material in said first liquid composition for a time selected to be between one minute and 24 hours.

42. The method of claim 41, wherein contacting said polymeric material with said first liquid composition comprises immersing said polymeric material in said first liquid composition for a time selected to be between 1 hour and 10 hours.

43. The method of claim 28, wherein contacting said paraben impregnated polymeric material with said second liquid composition comprises immersing said paraben impregnated polymeric material in said second liquid composition for a time selected to between 1 minute and 24 hours.

44. The method of claim 43, wherein contacting said paraben impregnated polymeric material with said second liquid composition comprises immersing said paraben impregnated polymeric material in said second liquid composition for a time selected to between 1 hour and 10 hours.

45. The method of claim 44, wherein contacting said paraben impregnated polymeric material with said second liquid composition comprises immersing said paraben impregnated polymeric material in said second liquid composition for a time selected to between 2 hours and 4 hours.

46. The method of claim 28, further comprising removing said paraben impregnated polymeric material from said first liquid composition; and rinsing said paraben impregnated polymeric material with distilled water.

47. The method of claim 46, further comprising drying said paraben impregnated polymeric material.

48. The method of claim 28, wherein said first and second liquid compositions are aqueous compositions.

49. The method of claim 28, wherein said medical device is a catheter.

50. A method of treating a patient having an indwelling medical device, comprising:
selecting a medical device comprising a polymeric material impregnated with a paraben and an organic dye, wherein at least one of said paraben and said organic dye exhibit antibacterial activity and said polymeric material is effective to release a portion of said at least one of said paraben and said organic dye to prohibit bacteria growth; and
implanting the medical device into the patient.
